(19) United States
(12) Patent Application Publication
(10) Pub. No.: US 2015/0100374 A1
(43) Pub. Date: Apr. 9, 2015

(54) WEARABLE TEXT PERSONALIZATION

(71) Applicant: Yahoo! Inc., Sunnyvale, CA (US)

(72) Inventor: Debashis Banjeree, Bengaluru (IN)

(21) Appl. No.: 14/050,179

(22) Filed: Oct. 9, 2013

(51) Int. Cl. G06Q 30/02

(52) U.S. Cl. CPC G06Q 30/0201
USPC 705/7.29

(57) ABSTRACT

In one embodiment, information indicating content that has been consumed by a user may be obtained, where at least a portion of the information is received from a mobile device such as a wearable device worn by the user while consuming the content, where the content is not generated or provided by the mobile device. A profile of the user may be updated based, at least in part, upon the information such that the information is associated with the user, where the information indicates one or more characteristics of the content. Further content to be provided to the user or characteristics thereof may be identified based, at least in part, upon the information.

### BACKGROUND

The disclosed embodiments relate generally to methods and apparatus for personalizing content.

Today, many web sites strive to personalize web services provided to individual users who visit the web sites. Such personalization is often based upon data that is collected when users interact with the web sites. For example, a web site may collect information indicating products that users have purchased via the web site. From this information, the web site may provide recommendations pertaining to other products that may be purchased via the web site. As another example, a web site providing search services may collect information indicating documents that users have accessed via the web site, enabling the web site to recommend further documents to those users.

### SUMMARY

The disclosed embodiments enable content to be personalized using information received from a device such as a wearable device. The personalized content may be provided via any medium including, but not limited to, the Internet or a physical medium such as paper.

In accordance with one embodiment, information indicating content being consumed by a user may be gathered by a mobile device such as a wearable device that is worn by the user while consuming the content, wherein the content is not generated or provided by the mobile device. The information indicating the content consumed by the user may be transmitted for use in identifying further content to be provided to the user, where the information indicates one or more characteristics of the content. The further content or characteristics thereof may be identified based, at least in part, upon the information.

In accordance with another embodiment, information indicating content that has been consumed by a user may be obtained, where at least a portion of the information is received from a mobile device such as a wearable device worn by the user while consuming the content, wherein the content is not generated or provided by the mobile device. A profile of the user may be updated based, at least in part, upon the information such that the information is associated with the user, where the information indicates one or more characteristics of the content. Further content to be provided to the user or characteristics thereof may be identified based, at least in part, upon the information.

The consumption of content may include the reading of content from a medium such as a paper medium. However, the consumption of content may also include other forms of consumption (e.g., listening to audio content).

In accordance with yet another embodiment, information indicating content that has been read by a user from a paper medium including the content may be obtained. A profile of the user may be updated based, at least in part, upon the information such that the information is associated with the user, where the information indicates one or more characteristics of the content. Further content to be provided to the user or characteristics thereof may be identified based, at least in part, upon the information.

Various embodiments may be implemented via a device comprising a processor, memory, and a display. The processor and memory are configured to perform one or more of the above described method operations. Other embodiments may be implemented via a computer readable storage medium having computer program instructions stored thereon that are arranged to perform one or more of the above described method operations.

These and other features and advantages of the disclosed embodiments will be presented in more detail in the following specification and the accompanying figures which illustrate by way of example the principles of the disclosed embodiments.

### BRIEF DESCRIPTION OF THE DRAWINGS

FIG. 1 is a diagram illustrating an example system in which various embodiments may be implemented.

FIG. 2 is a diagram illustrating another example system in which various embodiments may be implemented.

FIG. 3 is a diagram illustrating an example device via which various embodiments may be implemented.

FIG. 4 is a process flow diagram illustrating an example method of identifying personalized content to be provided to a device such as a wearable device in accordance with various embodiments.

FIG. 5 is a process flow diagram illustrating an example method of implementing a mobile device such as a wearable device in accordance with various embodiments.

FIG. 6 is a process flow diagram illustrating an example method of identifying personalized content to be provided based upon content that has been read from a paper medium in accordance with various embodiments.

FIG. 7 is a schematic diagram illustrating an example embodiment of a network in which various embodiments may be implemented.

FIG. 8 is a schematic diagram illustrating an example client device in which various embodiments may be implemented.

FIG. 9 is a schematic diagram illustrating an example computer system in which various embodiments may be implemented.

### DETAILED DESCRIPTION OF THE SPECIFIC EMBODIMENTS

Reference will now be made in detail to specific embodiments of the disclosure. Examples of these embodiments are illustrated in the accompanying drawings. While the disclosure will be described in conjunction with these specific embodiments, it will be understood that it is not intended to limit the disclosure to these embodiments. On the contrary, it is intended to cover alternatives, modifications, and equivalents as may be included within the spirit and scope of the disclosure as defined by the appended claims. In the following description, numerous specific details are set forth in order to provide a thorough understanding of the disclosure. The disclosed embodiments may be practiced without some or all of these specific details. In other instances, well known process operations have not been described in detail in order not to unnecessarily obscure the disclosure. The Detailed Description is not intended as an extensive or detailed discussion of known concepts, and as such, details that are known generally to those of ordinary skill in the relevant art may have been omitted or may be handled in summary fashion.

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Individuals have access to a number of information resources via the Internet. As a result, individuals may access content that is published via the Internet using a number of web sites. Content that is accessible via the web sites may include digital media items, which may include text, audio, video, photographs, and/or other images. For example, digital media items such as news articles may be accessed via a corresponding Uniform Resource Locator (URL).

Content accessible via the Internet may be contained within an object, such as a Web object, web page, web site, electronic document, or the like. An item in a collection of content may be referred to as an “item of content” or a “content item,” and may be retrieved from a “Web of Objects” comprising objects made up of a variety of types of content. For example, a newspaper available via a particular web site may serve as a collection of content that includes a plurality of content items. Each of the plurality of content items may include, for example, a newspaper article, advertisement, cartoon, photograph, or other image.

An enormous amount of information may be collected via web sites based upon various interactions (or lack thereof) of individuals with the digital media items provided via the web sites. For example, the web sites may ascertain whether the individuals access particular media items, which may or may not have been recommended by the web sites. As another example, the web sites may record a number of clicks by individuals to various media items. Using the collected information, the web sites may personalize the experience of the individuals accessing the web sites.

While content may be available on the Internet, some content is unavailable via the Internet or cannot easily be found on the Internet. In addition, even where particular content is available via the Internet, some individuals may prefer to view the content via another medium. For example, reading physical, paper newspapers is a daily habit for many individuals. Unfortunately, web sites are currently unable to gather valuable information pertaining to the reading of physical (e.g., paper) media.

In accordance with various embodiments, information pertaining to the consumption of content via a medium other than the Internet may be gathered and leveraged to personalize content provided to individuals. For example, the medium may include a paper medium, such as a paper newspaper or magazine. As another example, the medium may include a digital medium such as a tablet or other device that is not operatively connected to the Internet at the time of consumption of the content.

The content provided via various media may include, for example, text, audio, video, photographs, and/or other images. Where the content is provided via a paper medium, the content may include text, photographs, and/or other images. For example, a collection of content such as a newspaper or magazine may include a plurality of content items such as articles, advertisements, cartoons, photographs, and/or other images. The term content as used herein may refer to a collection of content or a specific content item, which may be one of a plurality of content items within a collection of content.

In accordance with various embodiments, wearable technology may be implemented to track content that is being consumed (e.g., viewed or read) by an individual. This may be accomplished, for example, by tracking and/or analyzing the content consumed by the individual. For example, text on page(s) viewed by the individual may be obtained, sampled, and/or analyzed. As another example, the movement of pupil(s) of the individual may be tracked to identify specific content item(s) within a page that are being viewed or read by the individual. Accordingly, through the use of wearable technology, information pertaining to content consumed by an individual may be gathered.

On most days of the week, paper newspapers may be 20-30 pages or more. On weekends, newspapers can be over 15-20% longer. As a result, a significant amount of paper is wasted, resulting in a significant impact on the environment.

In some embodiments, the information that is gathered may be applied to personalize content to be provided to individuals via a paper medium. For example, the information that is gathered may be used to generate a shortened and/or personalized version of a newspaper including content items such as articles that are most likely to interest a particular individual (or group of individuals sharing one or more characteristics). Accordingly, by reducing the size of the newspaper, valuable resources may be conserved.

In other embodiments, the information that is gathered may be applied to personalize content provided to individuals via the Internet. Accordingly, information gathered with respect to a paper medium (or other physical medium) may also be leveraged to personalize content provided to individuals via the Internet.

Example System

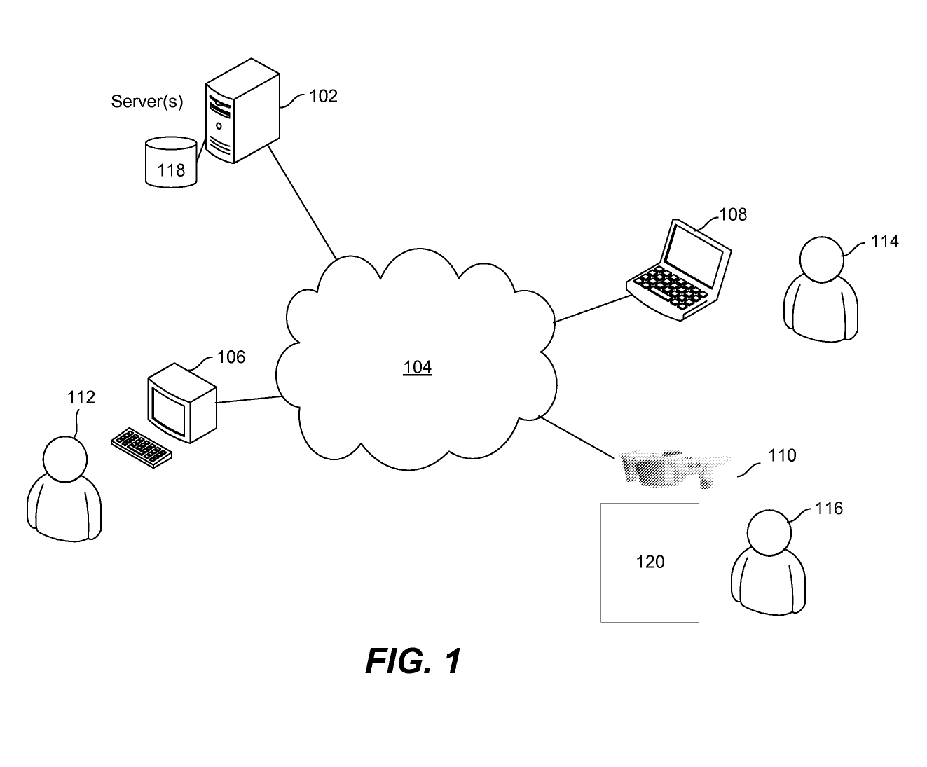

FIG. 1 is a diagram illustrating an example system in which various embodiments may be implemented. As shown in FIG. 1, the system may include one or more servers 102. In accordance with various embodiments, the servers 102 may be associated with a web site such as a social networking web site. Examples of social networking web sites include Yahoo, Facebook, Tumblr, LinkedIn, Flickr, and Meme. The server(s) 102 may enable the web site to provide a variety of services to its users. More particularly, users of the web site may perform activities such as access user accounts or public user profiles, interact with other members of the web site, transmit messages, upload files (e.g., photographs, videos), purchase goods or services, access information such as media items posted on the web site, etc.

The server(s) 102 may support requests (e.g., search requests, selection of a particular media item) that enable users to access media items provided via the web site. For example, the server(s) 102 may receive a request submitted via the Internet 104 from a first individual 112 via a computer 106. Similarly, the server(s) 102 may receive a request submitted via the Internet from a second individual 114 via a laptop 108 or other computing device, as shown. In response to a request, the server(s) 102 may provide the requested content. Each request may indicate content being requested or viewed by the corresponding individual 112, 114, respectively.

The server(s) 102 may gather information pertaining to the content being requested or viewed. In some implementations, the information that is gathered via the server(s) 102 may indicate one or more characteristics of the content 120, user data (e.g., user identifier), and/or other information (e.g., pertaining to interactions of the individual with the content and/or pertaining to circumstances surrounding the consumption of the content). The server(s) may store this information to one or more data stores 118, which may include one or more memories. A description of the information that may be stored in the data stores 118 will be described in further detail below.

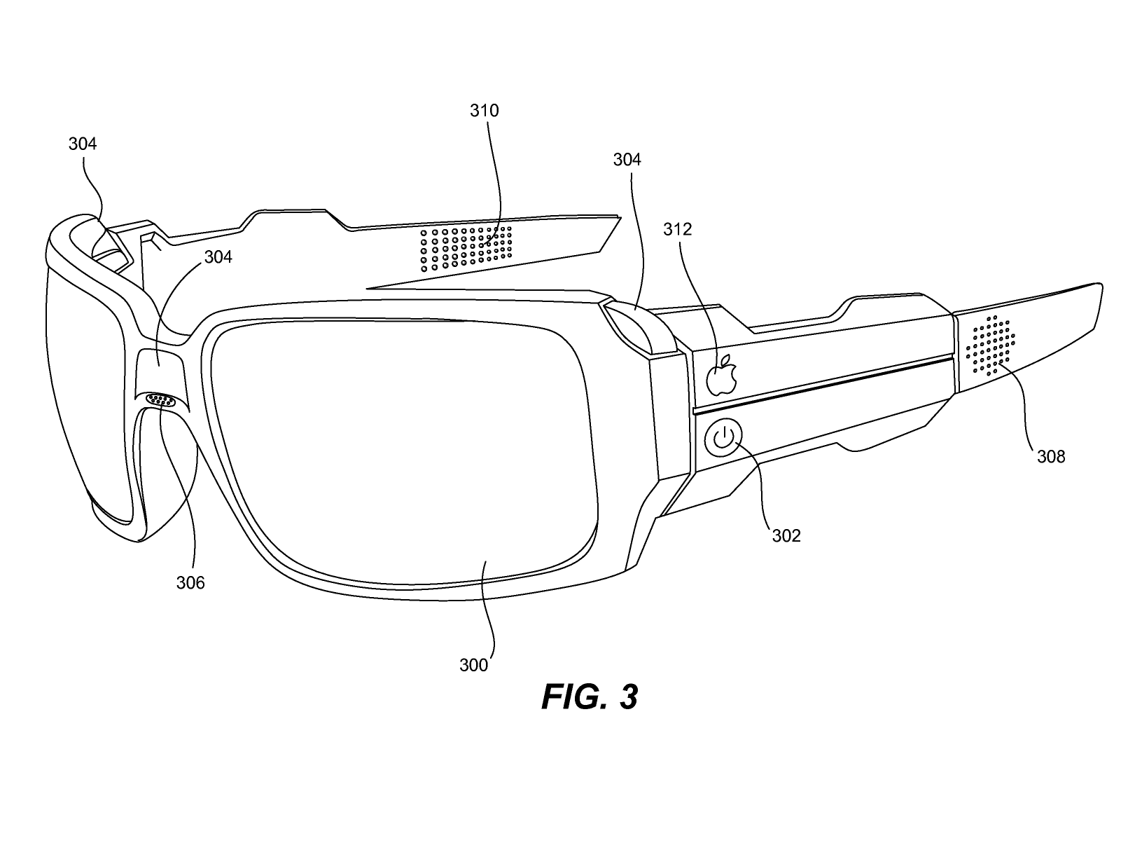

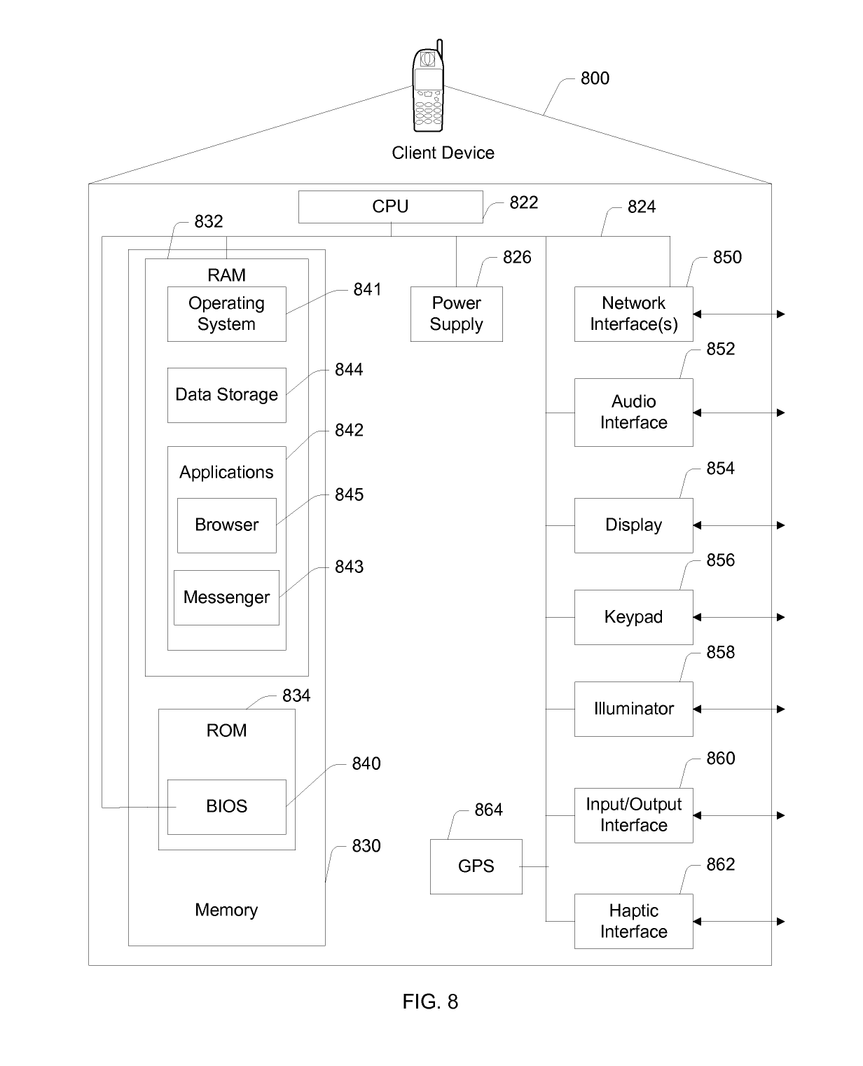

In addition, a third individual 116 may consume content while using a device 110 such as a wearable device or other mobile device, where the device 110 does not generate or otherwise provide the content. For example, the third individual 116 may be reading content 120 printed on a physical medium (e.g., paper) using the device 110. An example of a wearable device that may be implemented will be described in further detail below with reference to FIG. 3, while an example of a mobile device that may be implemented will be described in further detail below with reference to FIG. 8.

The consumption of the content by the third individual may be tracked via the device 110. While the consumption may include reading content, it is also possible that the consumption may take a different form. For example, the consumption may include listening to audio content. Accordingly, the examples described herein are merely illustrative, and other forms of content may be consumed, tracked, and/or personalized using a device such as that described herein.

The device 110 may be configured to dynamically gather information while the content 120 is being read or otherwise consumed by the third individual 116 using (e.g., wearing) the device 110. This information may be similar to that recorded when users access content provided on a web site via the server(s) 102. More particularly, the information that is gathered via the device 110 may indicate one or more characteristics of the content 120 being read or otherwise consumed by the third individual 116 using the device 110, user data pertaining to the third individual 116 (e.g., user identifier), and/or other information (e.g., pertaining to interactions of the third individual 116 with the content 120 and/or pertaining to circumstances surrounding the consumption of the content). The device 110 may send this information to the server(s) 102, which may store this information to the data stores 118.

The characteristics of the content may indicate information such as a primary subject or topic of the content, one or more key words, results of analysis of the content, one or more content categories indicating subject matter to which the content relates, an identifier of the content (e.g., URL, pointer to, or title of an article or advertisement), the content or a portion thereof, a section identifier indicating a pertinent section of a paper medium in which the content is printed (e.g., a particular section of a newspaper), and/or an author (e.g., of an article).

As will be described in further detail below, the server(s) 102 may obtain, collect, or otherwise receive information that pertains to content that is either accessed via the Internet (e.g., via the web site) or via another (e.g., physical printed) medium by a particular individual. This information may be stored to the data stores 118, enabling content to be personalized for the particular individual (or a group of individuals) based, at least in part, upon one or more of the characteristics of the content and/or a user profile of the individual. For example, the user profile may indicate interactions of the particular individual with the content (e.g., number of clicks or amount of time spent reading the content) and/or circumstances surrounding the consumption of the content (e.g., date and/or time). Information that may be maintained in a user profile will be described in further detail below.

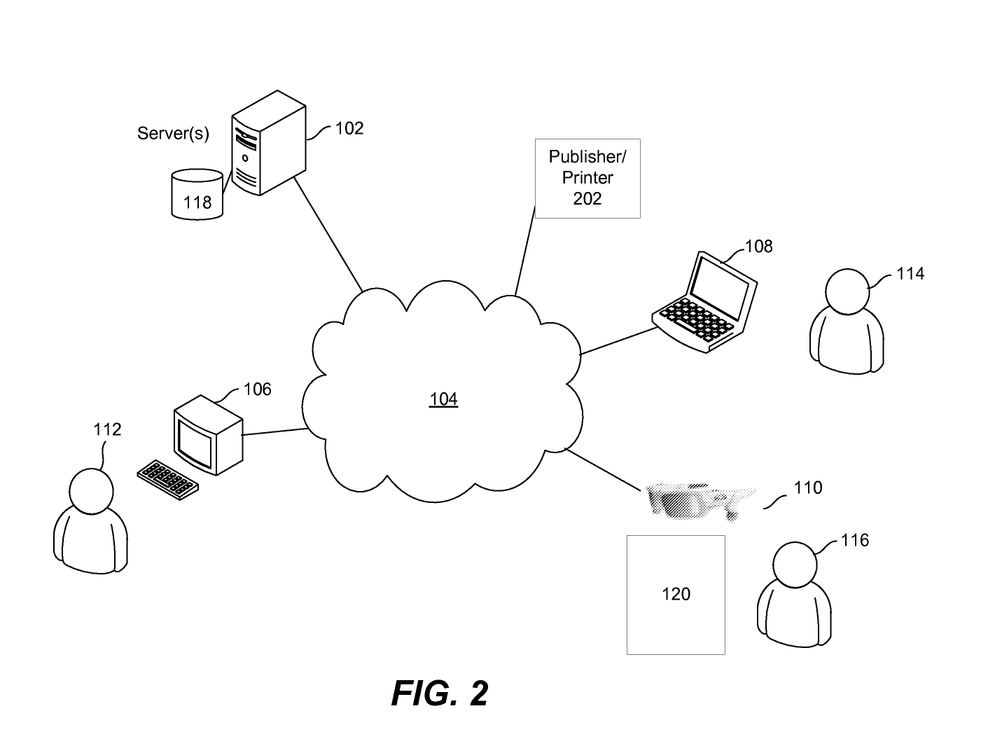

FIG. 2 is a diagram illustrating another example system in which various embodiments may be implemented. Personalization of content may include personalizing content provided by the web site via the server(s) 102. In addition, the personalization of content may include generating and distributing paper content such as a paper newspaper, either via the server(s) 102 or via a third-party Publisher 202, as shown in FIG. 2. For example, the server(s) may provide information to the third-party Publisher 202 that identifies one or more content items (e.g., articles and/or advertisements) or characteristics thereof to be distributed via a paper medium (e.g., a single newspaper), and may also indicate a particular order or placement of the content items within the paper medium. The information provided to the third-party Publisher 202 may also include an identifier of the individual, enabling the third-party Publisher 202 to look up an address of the individual in their records. Since the Publisher 202 may distribute personalized content, information identifying the individual may be printed on the personalized paper medium to ensure that each individual receives the appropriate personalized content.

Where content is accessed via the Internet, the server(s) 102 may gather information indicating one or more characteristics of the content, user data (e.g., user identifier), and/or other information (e.g., pertaining to interactions of the individual with the content and/or pertaining to circumstances surrounding the consumption of the content). For example the information that is gathered may pertain to one or more content items within a collection of content. The server(s) may obtain a set of characteristics of the content or of a particular content item via a variety of mechanisms, which may include analysis of text and/or image(s) within the content or the particular content item. In addition, the server(s) 102 may obtain a set of tags associated with the content or the particular content item.

In some embodiments, where content is consumed (e.g., read) by an individual using a device such as a wearable device or other mobile device, the device may gather information indicating one or more characteristics of the content, user data (e.g., user identifier), and/or other information (e.g., pertaining to interactions of the individual with the content and/or pertaining to circumstances surrounding the consumption of the content). As set forth above, the information that is gathered may pertain to one or more content items within a collection of content. The device 110 may obtain a set of characteristics of the content or a particular content item via a variety of mechanisms, which may include analysis of text and/or image(s) within the content or the particular content item. For example, the wearable device 110 may identify a title or key words in an article. The wearable device 110 may send the gathered information to the server(s).

In addition, where content is read by an individual using a device such as a wearable device or other mobile device, the information sent by the device to the server(s) 102 may include the content or a portion thereof. The server(s) 102 may then process the content or the portion thereof to gather further information, as described herein. In addition, the server(s) may compare at least a portion of the content to content in its data store(s) 118 in an attempt to look up information pertaining to the content. However, the server(s) may be unable to accurately or easily obtain information pertaining to the content, such as a primary subject of an article or a section of the newspaper in which the article has been printed.

In some instances, the server(s) 102 may communicate with the Publisher 202 to obtain information pertaining to the content (e.g., content item) such as a set of characteristics of a particular content item (e.g., article or advertisement) that is read by an individual using a wearable device. Thus, the server(s) may transmit information pertaining to the content item to the Publisher 202 (e.g., by transmitting the information via the Internet 104 to a server of the Publisher 202). For example, the information transmitted to the Publisher 202 may include an identity of the content or particular print medium (e.g., newspaper name and date), a page number, a position within the page, the content or a portion thereof (e.g., a subset of text or an image from the content item), and/or a title of the content item. The server of the Publisher 202 may look up at least a portion of this information in its own data store(s) (not shown to simplify illustration) to identify a set of characteristics associated with the content item. The Publisher 202 may then return information indicating one or more characteristics of the content item to the server(s) 102 associated with the web site. Alternatively, the Publisher 202 may return a digital version of the content item to the server(s) 102 so that the server(s) may store and/or process the content item to identify the characteristics of the content item.

Any information obtained by the server(s) 102, including information received from a device such as a wearable device and/or received from the Publisher 202, may be stored, maintained, and updated in the data stores 118 such that the information is associated with the user. Information that is stored, maintained, and updated in the data stores 118 will be described in further detail below.

### Data Stores

The data stores 118 may store content or references to content, which may include content items, hypertext links via which content items may be accessed, and/or URLs via which content items may be accessed. The content may be indexed for efficient retrieval.

In addition, the data stores 118 may store information such as the characteristics of the content, which may be stored in association with the content. More particularly, the content may be a collection of content or a specific content item, which may be one of a plurality of content items within a collection of content. For example, the characteristics of the content may indicate information such as an identifier of a content item (e.g., a pointer to a digital version of a content item or title of the content item), a primary subject or topic of the content item, one or more key words, results of analysis of the content item, one or more content categories indicating subject matter to which the content item relates, a section identifier indicating a pertinent section of a paper medium in which the content item is printed (e.g., a particular section of a newspaper), and/or an author of the content item (e.g., article).

Content and/or characteristics of content within a repository of media or multimedia within the data stores 118 may be annotated. Examples of content may include text, images, audio, video, or the like, which may be processed or stored in memory. The term “annotation,” as used herein, refers to descriptive or contextual content related to a content item, for example, collected from (or transmitted to) an individual, such as a user, and stored in association with the individual or the content item. Annotations may include various fields of descriptive content, such as a rating of a document, circumstances or context pertaining to the receipt of a document, a list of keywords identifying topics of a document, etc.

In some embodiments, as an individual interacts with a software application or a device such as a wearable device or other mobile device, descriptive content such as, for example, a date and/or time, may be identified and stored in the data stores 118 such that the descriptive content is stored in association with content. Descriptive content may also be stored along with contextual content. For example, how content such as a content item came to be identified (e.g., it was contained in a web page or was on a printed medium detected via a wearable device) may be stored in the data stores 118 as contextual content associated with the content. Contextual content, therefore, may identify circumstances surrounding receipt of content (e.g., date or time a content item was received or consumed and/or a source of the content item) and may be associated with descriptive content in the data stores 118. Contextual content, may, for example, be used to subsequently search for associated descriptive content. For example, a search for content items that have been read via a print medium (rather than a web site) may be identified. Alternatively, it is possible to search for content items that have been accessed via a web site (rather than a print medium). As another example, it is possible to identify content items that have been read via a particular print medium (e.g., newspapers vs magazines, a particular newspaper, etc.). Accordingly, this additional contextual content and/or descriptive content may enable personalization to be performed for a particular medium (e.g., a particular print medium) based upon the information that is most likely to be relevant.

In addition, the data stores 118 may include account information (e.g., data) for a plurality of user accounts. Therefore, account information pertaining to user accounts may be retained in one or more memories that are coupled to the server 102.

Account information may include financial information such as credit card information, enabling goods or services provided in association with the account to be purchased. In addition, the account information may include information pertaining to goods or services available to the user via the user account or used by the user. More particularly, the account information may indicate an amount and/or quality of the goods or services available to the user or used by the user. In addition, the account information may indicate a cost associated with the amount and/or quality of goods or services available to the user or used by the user.

The account information may also include or be linked to additional information pertaining to the user. For example, the server(s) 102 may have access to additional user information, which may be retained in one or more user logs stored in the data stores 118. This user information or a portion thereof may be referred to as a user profile. More particularly, the user profile may include public information that is available in a public profile and/or private information. Furthermore, the user profile may include information that has been submitted by the user and/or information that has been deduced or automatically collected by the system (e.g., based upon user action(s)). In accordance with various embodiments, as an individual consumes (e.g., reads) content provided via a web site or via another medium such as a physical medium (e.g., paper) while wearing a wearable device, the user profile may be periodically updated.

A profile builder may initiate generation of a profile, such as for users of an application, including a search engine or messaging application, for example. A profile builder may initiate generation of a user profile for use, for example, by a user, as well as by an entity that may have provided the application. For example, a profile builder may enhance relevance determinations and thereby assist in indexing, searching or ranking search results, as well as assist in the identification of further content to be provided via various media. Therefore, a provider such as a search engine provider may employ a profile builder.

A variety of mechanisms may be implemented to generate and/or update a profile including, but not limited to, collecting or mining navigation history, stored documents, tags, or annotations, to provide a few examples. In addition, the profile may be updated with information gathered as a result of the use of a device such as a wearable device (e.g., where content is read through lenses of the wearable device) or other mobile device. A profile builder may store a generated or updated profile.

Through the use of user profiles, for example, a web site such as a search engine provider may retrieve annotations, tags, stored pages, navigation history, or the like, which may be useful for making relevance determinations of search results. In addition, further content to be provided via a medium such as a printed medium may be identified using the user profiles.

The user information retained in the user logs 118 may include personal information such as demographic information and/or geographic information. Examples of demographic information include age and gender. Examples of geographic information include residence address, work address, and/or zip code.

Each time an individual performs online activities such as clicking on a content item (e.g., an advertisement or media item), purchasing goods or services, sending messages, retrieving messages, accessing a media item, posting information or content, or annotating content, information regarding such activity or activities may be retained as user data in the user logs 118. For instance, the user data that is retained in the user logs 118 may indicate the identity of web sites visited, identity of ads or content items that have been selected (e.g., clicked on) via the web site, and/or a timestamp indicating a date and/or time that the individual viewed or accessed the content item. Moreover, where the online publisher supports a search engine (e.g., via the server 102 or a separate search server), information associated with a search query, such as search term(s) of the search query, information indicating characteristics of search results that have been selected (e.g., clicked on) by the individual, and/or associated timestamp may also be retained in the user logs 118. Thus, the information may indicate whether the individual clicked on or viewed a content item and, if so, the number of clicks or views within a particular time period. An individual may be identified in the user logs 118 by a user ID (e.g., user account ID), information in a user cookie, etc.

In some embodiments, each time a user consumes content (e.g., presented on a paper medium) while using a mobile device such as a wearable device, information regarding such activity may be retained as user data in the user logs 118. More particularly, where a user reads content (e.g., a collection of content) while using (e.g., wearing) the device, the user logs 118 may be updated such that the information is associated with the user, where the information indicates: one or more characteristics of the content (e.g., newspaper), a date and/or time that the content was read, information pertaining to interactions of the individual with the content (e.g., an amount of time spent by the individual reading the content), information pertaining to circumstances surrounding the consumption of the content (e.g., weather, day of the week, time of year, etc.), and/or a user identifier. The characteristics of the content may indicate information such as a name or title of the content (e.g., name of newspaper), a date (e.g., of the newspaper), one or more content categories indicating subject matter to which the content relates, a primary subject or topic of the content, one or more key words, and/or other results of analysis of the content.

Moreover, with respect to particular content item(s) (e.g., within a collection of content) consumed by a user while using a mobile device such as a wearable device, the user logs 118 may be updated such that the information is associated with the user, where the information indicates: one or more characteristics of the content item (e.g., article or advertisement), a date and/or time that the content item was read, information pertaining to interactions of the individual with the content item (e.g., an amount of time spent by the individual reading the content item), information pertaining to circumstances surrounding the consumption of the content item (e.g., weather, day of the week, time of year, etc.), and/or a user identifier. For example, the characteristics of the content item may indicate information such as a name or title of the content containing the content item (e.g., name of newspaper), a date of the content (e.g., of the newspaper) or content item, a title of the content item (e.g. title of article in a newspaper), a section identifier indicating a pertinent section of the content in which the content item is presented or printed (e.g., a particular section of the newspaper such as Sports or Classifieds), an author, one or more content categories indicating subject matter to which the content item relates, a primary subject or topic of the content item, one or more key words, and/or other results of analysis of the content item.

While at least a portion of the information (e.g., an amount of time spent by the user reading the content) may be stored in the user logs 118, information such as the characteristics of the content may be stored in association with the content. For example, a record in the data store(s) 118 may include information pertaining to a particular newspaper or article within the newspaper. The information may be associated with each of the users that have consumed (e.g., read) the particular content (e.g., while wearing a wearable device such as that disclosed herein) by linking the record or information to the user profile of each of the users that have consumed the content. For example, the user profile of each of the users that have read the content may include a pointer to the record or the information.

The user logs 118 may further indicate whether the content (e.g., collection of content or particular content item) has been accessed via the Internet, or via another (e.g., paper medium). This may be implicit (e.g., by storing information pertaining to content read from a paper medium in a separate data structure). Alternatively, an indicator may be set, as appropriate, to indicate whether the content has been accessed via a paper medium. This indication may be used to make a variety of determinations, such as preferences of the user as to Internet vs other (e.g., paper) media, which may be general preferences or specific to various characteristics of the content (e.g., specific newspapers). For example, the system may determine that the user prefers to read a particular newspaper (e.g., New York Times) in paper form rather than electronic form. Accordingly, the indication or determinations may be used to determine the characteristic(s) of content to provide to a user and/or a suitable medium via which to provide the content to that user.

Based upon the information recorded in user profiles of individuals, a machine learning algorithm may learn how to identify characteristics of content items that may be of interest to individuals (or a similarly situated group of individuals) in the future. A machine learning algorithm may also be implemented to determine whether to provide particular content or content items via a web site or via a physical, printed (e.g., paper) medium. For example, where information pertaining to the reading of a particular newspaper (e.g., New York Times) by an individual is detected via a wearable device, it may be assumed that the individual wishes to receive further issues of the newspaper via the same (e.g., paper) medium. Such a machine learning algorithm may also assist in identifying an appropriate placement of a content item within a web page or physical medium prior to the generation of the web page or printing on the physical medium.

### Example Wearable Device

FIG. 3 is a diagram illustrating an example device via which various embodiments may be implemented. In one embodiment, the device is a mobile device that is wearable by the user of the device. In this example, the device is shaped in the form of glasses or sunglasses that a user may wear. However, it is important to note that this example is merely illustrative, and the device may be implemented in other forms.

As shown in this example, the device may include one or more transparent lenses 300 that enable a user to view or read items in his or her surroundings through the transparent lenses 300. In some embodiments, the lenses 300 may become opaque in order for the viewer to perform various tasks such as word processing functions and/or viewing of movies. In one embodiment, each of the lenses 300 may include a liquid crystal display (LCD).

In some embodiments, the device may support connection to a wireless network such as a cell phone network, localized Bluetooth™ devices, Worldwide Interoperability for Microwave Access (Wi-MAX) and/or Wireless Fidelity (Wi-Fi). In addition, the device may support other communication mechanisms such as Universal Serial Bus (USB), etc. A start button 302 may enable the user to turn the device on (or off). In one embodiment, when the device is off, the device may be used as a pair of sunglasses. When the device is on, the device may capture information that is pertinent to items that the user is consuming (e.g., viewing or reading). For instance, the information that is captured may include visual and/or audio information.

The visual information may be captured via one or more visual inputs such as visual sensors 304. For instance, each of the visual sensors 304 may be a still or video camera that is capable of capturing one or more still images or video images, respectively. These images may be captured in two-dimensional form or three-dimensional form. In one embodiment, the visual sensors 304 may include two sensors, where one of the sensors 304 is positioned at the left side of the lenses 300 of the device and another one of the sensors 304 is positioned at the right side of the lenses 300 of the device. For instance, the sensors 304 may be placed near the hinges of the device, as shown. In this manner, the two sensors 304 may capture images that would be viewed by a user's left and right eyes. The images captured via the two sensors 304 may be combined to replicate a single image that would be perceived by a user viewing the two separate images through the two different lenses 300. The visual sensors 304 may further include a third sensor at the center of the lenses 300 of the device. In another embodiment, one or more of the sensors 304 may track movement of the user's pupils to identify content (e.g., content items) being viewed by the user. The image(s) or other information pertaining to the consuming of the content, as discussed above, may be transmitted to the server(s) 102.

The information that may be captured by the device may include information identifying content items, text, and/or images in the field of vision of the device. For instance, the device may support pattern recognition. Thus, the device may process at least a portion of the captured information (e.g., one or more images) in order to identify content items, text, and/or images using pattern recognition. Therefore, pattern recognition may be used to identify letters, words, images, or other items.

In some embodiments, audio information may be captured via one or more audio sensors. For instance, the audio sensors may include one or more microphones. As shown in this example, one or more microphones 306 may be provided on the bridge of the device for purposes of capturing audio information. For example, the audio information may include voice commands from a user of the device and/or surrounding sounds. The device may also support voice recognition to assist in capturing voice commands. The audio sensors may also include one or more sound captors (e.g., microphones) 308 at various locations on the device. In this example, the sound captors 308 include two different sound captors, where each of the sound captors is positioned on the external side of one of the arms of the device. The device may be further configured to transmit information pertaining to the audio information or analysis thereof to the server(s) 102.

The device may further include a visual indicator 312 that signals that the user is online or offline. The visual indicator 312 may also be used to indicate whether the user is on a wireless call.

The identity of the user of the device may be ascertained via a variety of mechanisms. In some embodiments, an identity of the user (e.g., owner) of the device may be statically configured. Thus, the device may be keyed to an owner or multiple owners. In other embodiments, the device may automatically determine the identity of the user (e.g, wearer) of the device. For instance, a user of the device may be identified by deoxyribonucleic acid (DNA), retina scan, and/or finger print.

The identity of the user of the device may be used in various embodiments in order to tailor the operation of the device to the user's preferences. The user's preferences may be established remotely or locally via the device.

Information including the identity of the user may be transmitted by the device to the server(s) 102. Therefore, the server(s) 102 may associate information that is gathered with the user, enabling content to be personalized for the user based, at least in part, upon the gathered information.

It is important to note that the device shown and described with reference to FIG. 3 is merely illustrative, and therefore the device may be implemented in different forms. Furthermore, the device need not be wearable. For example, the device may be a handheld device. Moreover, the device may support some or all of the above listed features, as well as other features not described herein.

For example, while reading is often performed visually, some individuals may be visually impaired. As a result, printed content may be presented in the form of Braille. Various tools are available for converting Braille to speech content. In some embodiments, sound captors of the device may be used to capture audio information that has been generated by a conversion tool that has converted Braille to voice. Such a conversion tool may be implemented via the device or an external device.

### EXAMPLE EMBODIMENTS

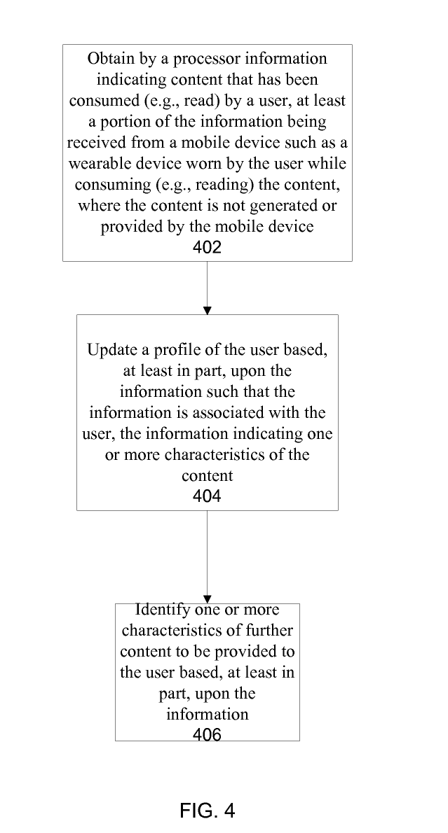

FIG. 4 is a process flow diagram illustrating an example method of identifying personalized content to be provided to a device such as a wearable device in accordance with various embodiments. A processor (e.g., of a server) may obtain information indicating content that has been consumed (e.g., read) by a user at 402, where at least a portion of the information is received from a mobile device. For example, the content read by the user may be at least a portion of a newspaper associated with a first day (e.g., Oct. 5, 2013). The content is not generated or provided by the mobile device. Rather, the content can be read from a paper medium or other physical medium. For example, the physical medium may be a digital medium such as a tablet that is not operatively connected (e.g., via the Internet) to the processor or the mobile device. In some embodiments, the mobile device may be a wearable device worn by the user while consuming (e.g., reading) the content.

As described above, at least a portion of the information may be received from the mobile device. Moreover, at least a portion of the information may be obtained by the server by performing processes such as look ups (e.g., of the content or portion thereof and/or associated characteristic(s)) and/or analysis of the content or portion thereof. In some embodiments, at least a portion of the information may be received from a third-party publisher. For example, the server may query the third-party publisher, which may perform a look up process (e.g., using the content or portion thereof and/or associated characteristic(s)) and return at least a portion of the information in response to the query.

For example, the server and/or the publisher may compare the content or portion thereof with at least a portion of a digital newspaper associated with the first day (e.g., New York Times, Oct. 5, 2013). Once the content is identified within the digital newspaper, characteristics of the content may be obtained (e.g., via a look up).

A profile of the user may be updated at 404 based, at least in part, upon the information such that the information is associated with the user. As described above, the information may indicate one or more characteristics of the content. In addition, the information may further indicate a date and/or time that the content was consumed (e.g., read), information pertaining to interactions of the individual with the content (e.g., an amount of time spent by the individual reading the content), information pertaining to circumstances surrounding the consumption of the content (e.g., weather, day of the week, time of year, etc.), and/or a user identifier.

Further content to be provided to the user or characteristics thereof may be identified at 406 based, at least in part, upon the information. For example, the further content may include at least a portion of a newspaper associated with a second day (e.g., New York Times, Oct. 6, 2013). The further content or characteristics thereof may also be identified based, at least in part, upon user information in the profile of the user, such as interests of the user, age, and/or gender of the user. In some implementations, a machine learning algorithm may be applied to identify the further content, or the characteristic(s) of any further content that is likely to be of interest to the user. For example, the machine learning algorithm may indicate those topics or categories of content that are likely to be of interest to the user.

The further content may be provided to the user via the Internet. Alternatively, the further content may be provided to the user via a paper medium.

For example, a physical paper newspaper including the further content may be generated or provided, where an identity of the user is associated with (e.g., printed on) the physical paper newspaper. This may be accomplished by providing information identifying characteristics of the further content to a publisher for generation of a paper medium including the further content.

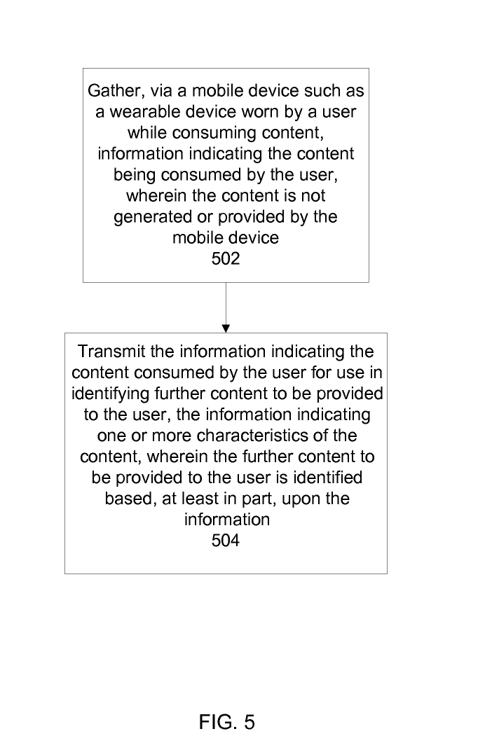

FIG. 5 is a process flow diagram illustrating an example method of implementing a mobile device such as a wearable device in accordance with various embodiments. Information indicating content being consumed (e.g., read) by a user may be gathered at 502 via a mobile device such as a wearable device that is worn by the user while consuming (e.g., reading) the content. For example, at least a portion of the information indicating content being read by the user may be gathered by detecting movement of one or more pupils of the user with respect to the content or with respect to a medium including the content. The content may be read from a variety of physical mediums such as a paper medium or a digital medium such as a tablet that is not operatively connected to the mobile device. As described above, the content is not generated or provided by the mobile device.

The information indicating the content consumed (e.g., read) by the user may be transmitted at 504 for use in identifying further content to be provided to the user. For example, the content may be read from a first physical paper newspaper such as that printed on a first day of a particular newspaper (e.g., Oct. 5, 2013 issue of New York Times) including the content, and the further content may be provided in a second physical paper newspaper such as that printed on a second day of the same newspaper (e.g., Oct. 6, 2013 issue of the New York Times).

As described above, the information or a portion thereof may be transmitted to a server of the web site and/or a third party publisher, enabling a medium such as a paper medium including the further content to be generated. The further content to be provided to the user or characteristics thereof may be identified based, at least in part, upon the information. The information may indicate one or more characteristics of the content and/or may include the content or a portion thereof. In addition, the information may further indicate a date and/or time that the content was consumed (e.g., read), information pertaining to interactions of the individual with the content (e.g., an amount of time spent by the individual reading the content), information pertaining to circumstances surrounding the consumption of the content (e.g., weather, day of the week, time of year, etc.), and/or a user identifier.

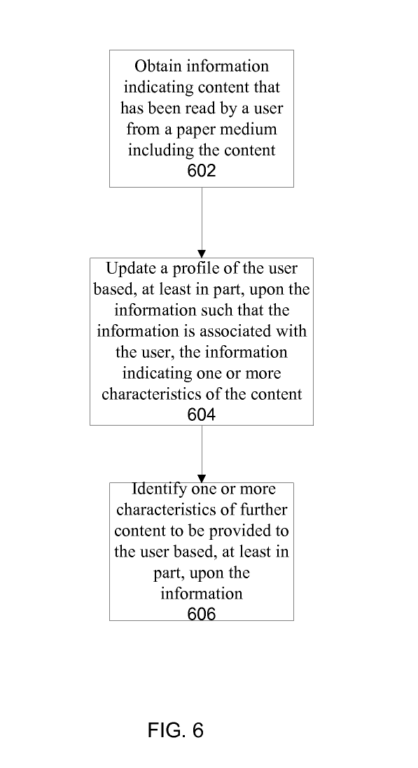

FIG. 6 is a process flow diagram illustrating an example method of identifying personalized content to be provided based upon content that has been read from a paper medium in accordance with various embodiments. Information indicating content that has been read by a user from a paper medium including the content may be obtained at 602. For example, the content read by the user may be at least a portion of a newspaper associated with a first day (e.g., Oct. 5, 2013). As described above, at least a portion of the information may be received from a mobile device such as a wearable device worn by the user while reading the content. Moreover, at least a portion of the information may be obtained by performing processes such as look ups and/or analysis of the content or portion thereof. In some embodiments, at least a portion of the information may be received from a third-party publisher (e.g., in response to a query).

A profile of the user may be updated at 604 based, at least in part, upon the information such that the information is associated with the user, the information indicating one or more characteristics of the content. As described above, the information may indicate one or more characteristics of the content. In addition, the information may further indicate a date and/or time that the content was read, information pertaining to interactions of the individual with the content (e.g., an amount of time spent by the individual reading the content), information pertaining to circumstances surrounding the consumption of the content (e.g., weather, day of the week, time of year, etc.), and/or a user identifier.

Further content to be provided to the user or characteristics thereof may be identified at 606 based, at least in part, upon the information. The further content may also be identified based, at least in part, upon user information in the profile of the user, such as interests of the user, age, and/or gender of the user. In some implementations, a machine learning algorithm may be applied to identify the further content, or the characteristic(s) of any further content that is likely to be of interest to the user. For example, the machine learning algorithm may indicate those topics or categories of content that are likely to be of interest to the user.

The further content may be provided to the user via the Internet. Alternatively, the further content may be provided to the user via a paper medium.

For example, a physical paper newspaper including the further content may be generated or provided, where an identity of the user is associated with (e.g., printed on) the physical paper newspaper. More particularly, the further content may be provided in at least a portion of a newspaper associated with a second day (e.g., Oct. 6, 2013). This may be accomplished by providing identifying information identifying characteristics of the further content to a publisher for generation of a paper medium including the further content.

Network

A network may couple devices so that communications may be exchanged, such as between a server and a client device or other types of devices, including between wireless devices coupled via a wireless network, for example. A network may also include mass storage, such as network attached storage (NAS), a storage area network (SAN), or other forms of computer or machine readable media, for example. A network may include the Internet, one or more local area networks (LANs), one or more wide area networks (WANs), wire-line type connections, wireless type connections, or any combination thereof. Likewise, sub-networks, such as may employ differing architectures or may be compliant or compatible with differing protocols, may interoperate within a larger network. Various types of devices may, for example, be made available to provide an interoperable capability for differing architectures or protocols. As one illustrative example, a router may provide a link between otherwise separate and independent LANs.

A communication link or channel may include, for example, analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. Furthermore, a computing device or other related electronic devices may be remotely coupled to a network, such as via a telephone line or link, for example.

Content Distribution Network

A distributed system may include a content distribution network. A “content delivery network” or “content distribution network” (CDN) generally refers to a distributed content delivery system that comprises a collection of computers or computing devices linked by a network or networks. A CDN may employ software, systems, protocols or techniques to facilitate various services, such as storage, caching, communication of content, or streaming media or applications. Services may also make use of ancillary technologies including, but not limited to, “cloud computing,” distributed storage, DNS request handling, provisioning, signal monitoring and reporting, content targeting, personalization, or business intelligence. A CDN may also enable an entity to operate or manage another's site infrastructure, in whole or in part.

Peer-to-Peer Network

A peer-to-peer (or P2P) network may employ computing power or bandwidth of network participants in contrast with a network that may employ dedicated devices, such as dedicated servers, for example; however, some networks may employ both as well as other approaches. A P2P network may typically be used for coupling nodes via an ad hoc arrangement or configuration. A peer-to-peer network may employ some nodes capable of operating as both a “client” and a “server.”

Wireless Network

A wireless network may couple client devices with a network. A wireless network may employ stand-alone ad-hoc networks, mesh networks, Wireless LAN (WLAN) networks, cellular networks, or the like.

A wireless network may further include a system of terminals, gateways, routers, or the like coupled by wireless radio links, or the like, which may move freely, randomly or organize themselves arbitrarily, such that network topology may change, at times even rapidly. A wireless network may further employ a plurality of network access technologies, including Long Term Evolution (LTE), WLAN, Wireless Router (WR) mesh, or 2nd, 3rd, or 4th generation (2G, 3G, or 4G) cellular technology, or the like. Network access technologies may enable wide area coverage for devices, such as client devices with varying degrees of mobility, for example.

For example, a network may enable RF or wireless type communication via one or more network access technologies, such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, 802.11b/g/n, or the like. A wireless network may include virtually any type of wireless communication mechanism by which signals may be communicated between devices, such as a client device or a computing device, between or within a network, or the like.

Internet Protocol

Signal packets communicated via a network, such as a network of participating digital communication networks, may be compatible with or compliant with one or more protocols. Signaling formats or protocols employed may include, for example, TCP/IP, UDP, DECnet, NetBEUI, IPX, Appletalk, or the like. Versions of the Internet Protocol (IP) may include IPv4 or IPv6.

The Internet refers to a decentralized global network of networks. The Internet includes LANs, WANs, wireless networks, or long haul public networks that, for example, allow signal packets to be communicated between LANs. Signal packets may be communicated between nodes of a network, such as, for example, to one or more sites employing a local network address. A signal packet may, for example, be communicated over the Internet from a user site via an access node coupled to the Internet. Likewise, a signal packet may be forwarded via network nodes to a target site coupled to the network via a network access node, for example. A signal packet communicated via the Internet may, for example, be routed via a path of gateways, servers, etc. that may route the signal packet in accordance with a target address and availability of a network path to the target address.

Social Network

The term “social network” refers generally to a network of individuals, such as acquaintances, friends, family, colleagues, or co-workers, coupled via a communications network or via a variety of sub-networks. Potentially, additional relationships may subsequently be formed as a result of social interaction via the communications network or sub-networks. A social network may be employed, for example, to identify additional connections for a variety of activities, including, but not limited to, dating, job networking, receiving or providing service referrals, content sharing, creating new associations, maintaining existing associations, identifying potential activity partners, performing or supporting commercial transactions, or the like.

A social network may include individuals with similar experiences, opinions, education levels or backgrounds. Subgroups may exist or be created according to user profiles of individuals, for example, in which a subgroup member may belong to multiple subgroups. An individual may also have multiple “1:few” associations within a social network, such as for family, college classmates, or co-workers.

An individual's social network may refer to a set of direct personal relationships or a set of indirect personal relationships. A direct personal relationship refers to a relationship for an individual in which communications may be individual to individual, such as with family members, friends, colleagues, co-workers, or the like. An indirect personal relationship refers to a relationship that may be available to an individual with another individual although no form of individual to individual communication may have taken place, such as a friend of a friend, or the like. Different privileges or permissions may be associated with relationships in a social network. A social network also may generate relationships or connections with entities other than a person, such as companies, brands, or so called ‘virtual persons.’ An individual's social network may be represented in a variety of forms, such as visually, electronically or functionally. For example, a “social graph” or “socio-gram” may represent an entity in a social network as a node and a relationship as an edge or a link.

Multi-Modal Communication (MMC)

Individuals within one or more social networks may interact or communicate with other members of a social network via a variety of devices. Multi-modal communication technologies refers to a set of technologies that permit interoperable communication across multiple devices or platforms, such as cellphones, smart phones, tablet computing devices, personal computers, televisions, SMS/MMS, email, instant messenger clients, forums, social networking sites (such as Facebook, Twitter, or Google), or the like.

Network Architecture

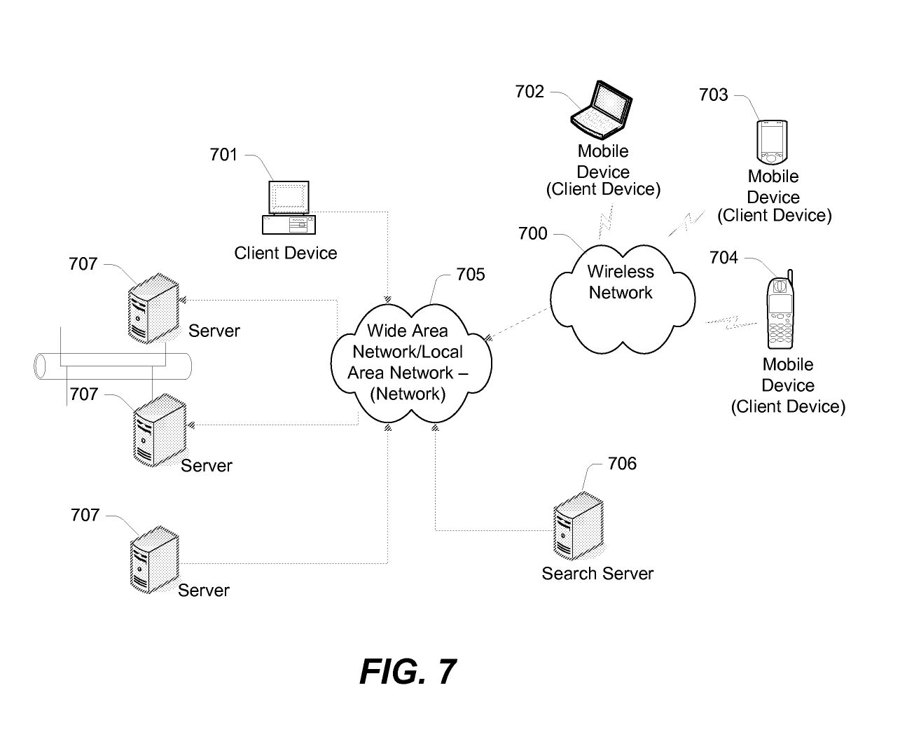

The disclosed embodiments may be implemented in any of a wide variety of computing contexts. FIG. 7 is a schematic diagram illustrating an example embodiment of a network. Other embodiments that may vary, for example, in terms of arrangement or in terms of type of components, are also intended to be included within claimed subject matter. Implementations are contemplated in which users interact with a diverse network environment. As shown, FIG. 7, for example, includes a variety of networks, such as a LAN/WAN 705 and wireless network 700, a variety of devices, such as client devices 701-704, and a variety of servers such as content server(s) 707 and search server 706. The servers may also include an ad server (not shown). As shown in this example, the client devices 701-704 may include one or more mobile devices 702, 703, 704. Client device(s) 701-704 may be implemented, for example, via any type of computer (e.g., desktop, laptop, tablet, etc.), media computing platforms (e.g., cable and satellite set top boxes), handheld computing devices (e.g., PDAs), cell phones, or any other type of computing or communication platform.

The disclosed embodiments may be implemented in some centralized manner. This is represented in FIG. 7 by server(s) 707, which may correspond to multiple distributed devices and data store(s). The server(s) 707 and/or corresponding data store(s) may store user account data and other user information.

Server

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

Servers may vary widely in configuration or capabilities, but generally a server may include one or more central processing units and memory. A server may also include one or more mass storage devices, one or more power supplies, one or more wired or wireless network interfaces, one or more input/output interfaces, or one or more operating systems, such as Windows Server, Mac OS X, Unix, Linux, FreeBSD, or the like.

Content Server

A content server may comprise a device that includes a configuration to provide content via a network to another device. A content server may, for example, host a site, such as a social networking site, examples of which may include, without limitation, Flicker, Twitter, Facebook, LinkedIn, or a personal user site (such as a blog, vlog, online dating site, etc.). A content server may also host a variety of other sites, including, but not limited to business sites, educational sites, dictionary sites, encyclopedia sites, wikis, financial sites, government sites, etc.

A content server may further provide a variety of services that include, but are not limited to, web services, third-party services, audio services, video services, email services, instant messaging (IM) services, SMS services, MMS services, FTP services, voice over IP (VOIP) services, calendaring services, photo services, or the like. Examples of content may include text, images, audio, video, or the like, which may be processed in the form of physical signals, such as electrical signals, for example, or may be stored in memory, as physical states, for example. Examples of devices that may operate as a content server include desktop computers, multiprocessor systems, microprocessor-type or programmable consumer electronics, etc.

Crawler

A crawler may be operable to communicate with a variety of content servers, typically via a network. In some embodiments, a crawler starts with a list of URLs to visit. The list may be called a seed list. As the crawler visits the URLs in the seed list, it identifies all the hyperlinks in the page and adds them to a list of URLs to visit, called the crawl frontier. URLs from the crawler frontier are recursively visited according to a set of policies. A crawler typically retrieves files by generating a copy for storage, such as local cache storage. A cache refers to a persistent storage device. A crawler may likewise follow links, such as HTTP hyperlinks, in the retrieved file to additional files and may retrieve those files by generating copy for storage, and so forth. A crawler may therefore retrieve files from a plurality of content servers as it “crawls” across a network.

Indexing

An indexer may be operable to generate an index of content, including associated contextual content, such as for one or more databases, which may be searched to locate content, including contextual content. An index may include index entries, wherein an index entry may be assigned a value referred to as a weight. An index entry may include a portion of the database. In some embodiments, an indexer may use an inverted index that stores a mapping from content to its locations in a database file, or in a document or a set of documents. A record level inverted index contains a list of references to documents for each word. A word level inverted index additionally contains the positions of each word within a document. A weight for an index entry may be assigned. For example, a weight, in one example embodiment may be assigned substantially in accordance with a difference between the number of records indexed without the index entry and the number of records indexed with the index entry.

Client Device

A user may access content via a client device. FIG. 8 is a schematic diagram illustrating an example embodiment of a client device in which various embodiments may be implemented. A client device may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device, a Personal Digital Assistant (PDA), a handheld computer, a tablet computer, a laptop computer, a set top box, a wearable computer, an integrated device combining various features, such as features of the forgoing devices, or the like.

As shown in this example, a client device 800 may include one or more central processing units (CPUs) 822, which may be coupled via connection 824 to a power supply 826 and a memory 830. The memory 830 may include random access memory (RAM) 832 and read only memory (ROM) 834. The ROM 834 may include a basic input/output system (BIOS) 840.

The RAM 832 may include an operating system 841. More particularly, a client device may include or may execute a variety of operating systems, including a personal computer operating system, such as a Windows, iOS or Linux, or a mobile operating system, such as iOS, Android, or Windows Mobile, or the like. The client device 800 may also include or may execute a variety of possible applications 842 (shown in RAM 832), such as a client software application such as messenger 843, enabling communication with other devices, such as communicating one or more messages, such as via email, short message service (SMS), or multimedia message service (MMS), including via a network, such as a social network, including, for example, Facebook, LinkedIn, Twitter, Flickr, or Google, to provide only a few possible examples. The client device 800 may also include or execute an application to communicate content, such as, for example, textual content, multimedia content, or the like, which may be stored in data storage 844. A client device may also include or execute an application such as a browser 845 to perform a variety of possible tasks, such as browsing, searching, playing various forms of content, including locally stored or streamed video, or games (such as fantasy sports leagues).

The client device 800 may send or receive signals via one or more interface(s). As shown in this example, the client device 800 may include one or more network interfaces 850. The client device 800 may include an audio interface 852. In addition, the client device 800 may include a display 854 and an illuminator 858. The client device 800 may further include an Input/Output interface 860, as well as a Haptic Interface 862 supporting tactile feedback technology.

The client device 800 may vary in terms of capabilities or features. Claimed subject matter is intended to cover a wide range of potential variations. For example, a cell phone may include a keypad such 856 such as a numeric keypad or a display of limited functionality, such as a monochrome liquid crystal display (LCD) for displaying text. In contrast, however, as another example, a web-enabled client device may include one or more physical or virtual keyboards, mass storage, one or more accelerometers, one or more gyroscopes, global positioning system (GPS) 864 or other location identifying type capability, or a display with a high degree of functionality, such as a touch-sensitive color 2D or 3D display, for example. The foregoing is provided to illustrate that claimed subject matter is intended to include a wide range of possible features or capabilities.

According to various embodiments, input may be obtained using a wide variety of techniques. For example, input for downloading or launching an application may be obtained via a graphical user interface from a user's interaction with a local application such as a mobile application on a mobile device, web site or web-based application or service and may be accomplished using any of a variety of well-known mechanisms for obtaining information from a user. However, it should be understood that such methods of obtaining input from a user are merely examples and that input may be obtained in many other ways.

Regardless of the system's configuration, it may employ one or more memories or memory modules configured to store data, program instructions for the general-purpose processing operations and/or the inventive techniques described herein. The program instructions may control the operation of an operating system and/or one or more applications, for example. The memory or memories may also be configured to store instructions for performing the disclosed methods, graphical user interfaces to be displayed in association with the disclosed methods, etc.

Because such information and program instructions may be employed to implement the systems/methods described herein, the disclosed embodiments relate to machine readable media that include program instructions, state information, etc. for performing various operations described herein. Examples of machine-readable media include, but are not limited to, magnetic media such as hard disks, floppy disks, and magnetic tape; optical media such as CD-ROM disks; magneto-optical media such as optical disks; and hardware devices that are specially configured to store and perform program instructions, such as ROM and RAM. Examples of program instructions include both machine code, such as produced by a compiler, and files containing higher level code that may be executed by the computer using an interpreter.

Computer program instructions with which various embodiments are implemented may be stored in any type of computer-readable media, and may be executed according to a variety of computing models including a client/server model, a peer-to-peer model, on a stand-alone computing device, or according to a distributed computing model in which various of the functionalities described herein may be effected or employed at different locations.

The disclosed techniques may be implemented in any suitable combination of software and/or hardware system, such as a web-based server or desktop computer system. Moreover, a system implementing various embodiments may be a portable device, such as a laptop or cell phone. An apparatus and/or web browser may be specially constructed for the required purposes, or it may be a general-purpose computer selectively activated or reconfigured by a computer program and/or data structure stored in the computer. The processes presented herein are not inherently related to any particular computer or other apparatus. In particular, various general-purpose machines may be used with programs written in accordance with the teachings herein, or it may be more convenient to construct a more specialized apparatus to perform the disclosed method steps.

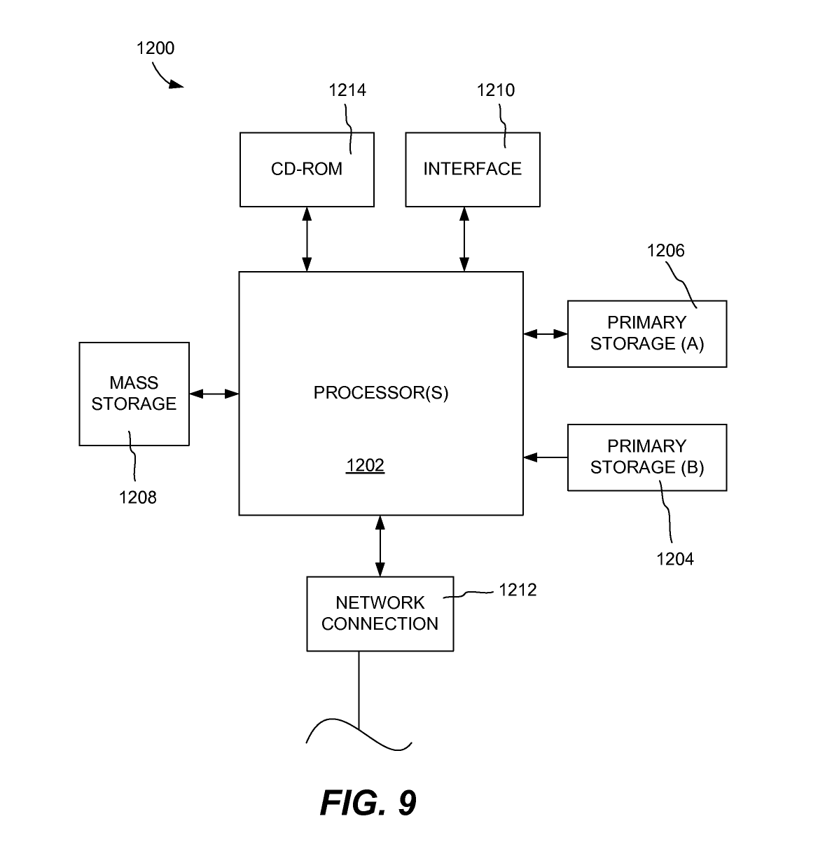

FIG. 9 illustrates a typical computer system that, when appropriately configured or designed, can serve as a system via which various embodiments may be implemented. The computer system 1200 includes any number of CPUs 1202 that are coupled to storage devices including primary storage 1206 (typically a RAM), primary storage 1204 (typically a ROM). CPU 1202 may be of various types including microcontrollers and microprocessors such as programmable devices (e.g., CPLDs and FPGAs) and unprogrammable devices such as gate array ASICs or general purpose microprocessors. As is well known in the art, primary storage 1204 acts to transfer data and instructions uni-directionally to the CPU and primary storage 1206 is used typically to transfer data and instructions in a bi-directional manner. Both of these primary storage devices may include any suitable computer-readable media such as those described above. A mass storage device 1208 is also coupled bi-directionally to CPU 1202 and provides additional data storage capacity and may include any of the computer-readable media described above. Mass storage device 1208 may be used to store programs, data and the like and is typically a secondary storage medium such as a hard disk. It will be appreciated that the information retained within the mass storage device 1208, may, in appropriate cases, be incorporated in standard fashion as part of primary storage 1206 as virtual memory. A specific mass storage device such as a CD-ROM 1214 may also pass data uni-directionally to the CPU.

CPU 1202 may also be coupled to an interface 1210 that connects to one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 1202 optionally may be coupled to an external device such as a database or a computer or telecommunications network using an external connection as shown generally at 1212. With such a connection, it is contemplated that the CPU might receive information from the network, or might output information to the network in the course of performing the method steps described herein.

Although the foregoing embodiments have been described in some detail for purposes of clarity of understanding, it will be apparent that certain changes and modifications may be practiced within the scope of the appended claims. Therefore, the present embodiments are to be considered as illustrative and not restrictive, and are not to be limited to the details given herein, but may be modified within the scope and equivalents of the appended claims.

What is claimed is:

1. A method, comprising:
obtaining by a processor information indicating content that has been consumed by a user, at least a portion of the information being received from a mobile device, wherein the content is not generated or provided by the mobile device;
updating a profile of the user based, at least in part, upon the information such that the information is associated with the user, the information indicating one or more characteristics of the content; and
identifying one or more characteristics of further content to be provided to the user based, at least in part, upon the information.

2. The method as recited in claim 1, wherein the mobile device is a wearable device worn by the user while consuming the content, wherein the information indicates content that has been read by the user, the at least a portion of the information being received from the wearable device worn by the user while reading the content.

3. The method as recited in claim 1, wherein the information indicates content that has been read by the user, wherein the content is read from a paper medium including the content or a digital medium that is not operatively connected to the mobile device or the processor.

4. The method as recited in claim 1, further comprising:
providing the further content to the user via the Internet

5. The method as recited in claim 1, further comprising:
generating or providing a physical paper newspaper including the further content;
wherein an identity of the user is associated with the physical paper newspaper.

6. The method as recited in claim 1, further comprising:
providing identifying information indicating the characteristics of the further content to a publisher for generation of a paper medium including the further content.

7. The method as recited in claim 1, further comprising:
generating at least a portion of the information and/or receiving at least a portion of the information from a publisher.

8. The method as recited in claim 1, wherein the content is at least a portion of a newspaper associated with a first day, and wherein the further content is at least a portion of a newspaper associated with a second day.

9. A system, comprising:
one or more processors; and
one or more memories, at least one of the processors or memories being configured to:
obtain information indicating content that has been read by a user from a paper medium including the content;
updating a profile of the user based, at least in part, upon the information such that the information is associated with the user, the information indicating one or more characteristics of the content; and
identifying one or more characteristics of further content to be provided to the user based, at least in part, upon the information.

10. The system as recited in claim 9, wherein at least a portion of the information is received from a wearable device.

11. The system as recited in claim 9, at least one of the processors or memories being configured to perform steps, further comprising:
providing via the Internet the further content.

12. The system as recited in claim 9, at least one of the processors or memories being configured to perform steps, further comprising:
generating or providing a physical paper newspaper including the further content, wherein an identity of the user is associated with the physical paper newspaper.

13. The system as recited in claim 9, wherein the content is at least a portion of a newspaper associated with a first day, and wherein the further content is at least a portion of a newspaper associated with a second day.

14. The system as recited in claim 9, at least one of the processors or memories being configured to perform steps, further comprising:
providing identifying information indicating the one or more characteristics of the further content to a publisher for generation of a paper medium including the further content.

15. A method, comprising:
gathering, via a mobile device, information indicating content being consumed by a user, wherein the content is not generated or provided by the mobile device; and
transmitting the information indicating the content consumed by the user for use in identifying further content to be provided to the user, the information indicating one or more characteristics of the content;
wherein the further content to be provided to the user is identified based, at least in part, upon the information.

16. The method as recited in claim 15, wherein the mobile device is a wearable device worn by the user while consuming the content, wherein gathering comprises obtaining via the wearable device the information indicating the content being read by the user while wearing the wearable device.

17. The method as recited in claim 15, wherein the content is read from a first physical paper newspaper including the content, and the further content is to be provided in a second physical paper newspaper.

18. The method as recited in claim 15, wherein gathering comprises:
detecting movement of one or more pupils of the user with respect to the content or with respect to a medium including the content.

19. The method as recited in claim 15, wherein the information indicates content that has been read by the user, wherein the content is read from a paper medium including the content or a digital medium that is not operatively connected to the mobile device or the processor.

20. The method as recited in claim 15, wherein transmitting the information comprises:
transmitting the information to a server, enabling a paper medium including the further content to be generated.
